(19) United States
(12) Patent Application Publication
(10) Pub. No.: US 2004/0144499 A1
(43) Pub. Date: Jul. 29, 2004

(54) Decorative garage screen door and method therefor

(76) Inventor: Christopher W. Pannell, North Las Vegas, NV (US)

Correspondence Address: WEISS & MOY PC, 4204 NORTH BROWN AVENUE, SCOTTSDALE, AZ, 85251, US

(21) Appl. No.: 10/351,522

(22) Filed: Jan. 27, 2003

(51) Int. Cl. E06B 3/48

(52) U.S. Cl. 160/113

(57) ABSTRACT

A method and a computer program for facilitating previewing an area rug or other floor covering in a room, hallway, or other intended environment wherein the area rug will be placed, located, or otherwise used. Broadly, a digital image of the area rug is shaded, scaled, angled, or otherwise manipulated to reflect the corresponding conditions of the environment of use; combined with a digital image of the intended environment of use so as to present an accurately sized and realistic preview presentation image; and made available, such as, for example, via a network, for viewing. Any furniture or other objects appearing in the digital image of the environment of use to overlap an area wherein the area rug will be located are accommodated with a labor-reducing masking technique, thereby eliminating any requirement that a customer physically move the objects prior to generating the digital image of the environment of use.

### RELATED APPLICATIONS

This application claims priority benefit, with regard to all common subject matter, of provisional application titled “METHOD AND COMPUTER PROGRAM FOR PREVIEWING AREA RUG IN ENVIRONMENT OF USE”, filed Jan. 28, 2003, which is hereby incorporated into the present application by reference.

### BACKGROUND OF THE INVENTION

1. Field of the Invention

The present invention relates broadly to tools for previewing area rugs or other floor coverings in the environments wherein the floor coverings will be placed or otherwise used. More particularly, the invention relates to a method and computer program for previewing an area rug or other floor covering in a room, hallway, or other intended environment wherein the floor covering will be placed, located, or otherwise used, wherein a digital image of the floor covering is shaded, scaled, angled or otherwise manipulated to reflect corresponding conditions of the environment of use, and combined with a digital image of the environment of use so as to present a substantially accurate and realistic preview presentation.

2. Description of the Prior Art

It is often desirable to see or preview an area rug or other floor covering in its intended environment of use, typically a room, hallway, or other space within a house, prior to purchasing the floor covering. More particularly, it is desirable to determine whether a coloration, pattern, size, and shape of the floor covering will be visually appealing given the colors, size, and lighting of the room and the furniture or fixtures therein.

One method of facilitating or accomplishing such a preview is to place and arrange the actual floor covering or a sample thereof within the room and to position any furniture or fixtures upon or about the floor covering as they would be normally arranged. Though this method may provide the most accurate preview presentation, it suffers from a number of limitations and disadvantages, including, for example, the prohibitive cost, time, and labor involved in previewing multiple floor coverings. Using this method, a variety of floor coverings must be transported to a customer's home, the furniture must be moved aside, a first one of the floor coverings carried into the room and arranged, the furniture replaced, and the result viewed and considered by the customer. This process must be repeated at least once for each of the variety of floor coverings, and may be repeated multiple times for those floor coverings from which the purchaser finds it difficult to choose. Thus, the cost, time, and labor involved in accomplishing this method make it impractical, uneconomical, and generally unsuitable for most situations.

Another method of facilitating or accomplishing such a preview is to view images of the floor coverings and attempt to visualize each floor covering arranged in the room. Though this method may provide a more practical and economical preview mechanism than the above-described method, it too suffers from a number of limitations and disadvantages, including, for example, that it can result in less-than-realistic and potentially misleading perceptions on the part of the customer. This method could be implemented in a number of ways, such as, for example, providing digital images of the floor coverings for download via a network by the customer so that they may be previewed within the home or actual room of intended use. Unfortunately, the digital images of the floor coverings are often taken from a perpendicular perspective and under perfect lighting conditions. Because this perspective and these conditions do not typically occur in the environment of use, the visualization may be flawed and inaccurate such that the customer is dismayed and disappointed when the actual floor covering is arranged within the room. Colors or patterns, for example, that seem bright or otherwise desirable when viewed under perfect lighting conditions may seem substantially less desirable when viewed under actual conditions.

Another method of facilitating or accomplishing such a preview involves software that allows a user to manipulate a digital image of the environment of use. Such software is typically limited to changing floor or wall colors, such as when previewing wall-to-wall carpeting. Unfortunately, this software does not allow for manipulating only portions of the floor or wall or inserting or combining other digital images with the digital image of the environment of use, as would be necessary for previewing area rugs or other floor coverings that are less than the entire floor area in size. Furthermore, this software is typically only concerned with color and, perhaps, pattern, and not with perspective or shading. As mentioned, colors or patterns that seem bright or otherwise desirable when viewed under perfect lighting conditions may seem substantially less desirable when viewed under actual conditions.

Due to these and other problems and disadvantages in the art, an improved method or mechanism is needed for accurately previewing an area rug or other floor covering.

### SUMMARY OF THE INVENTION

The present invention overcomes the above-described and other problems and disadvantages by providing a method and computer program to allow for and facilitate previewing an area rug or other floor covering in a room or other intended environment wherein the floor covering will be placed, located, or otherwise used. In more detail, a digital image of the floor covering is shaded, scaled, angled, or otherwise manipulated to reflect the corresponding conditions of the environment of use; inserted into a digital image of the environment of use so as to present a substantially accurate and realistic preview presentation image; and then made available, such as, for example, via a network, for viewing.

The method may be implemented using a system broadly comprising first and second personal computers (PCs); a network; and a digital camera or scanner, all of which may be substantially conventional in both form and function. Broadly, the method proceeds as follows. The customer may first move all or some of any furniture or other objects from the particular area of the environment of use wherein which the floor covering will be located. It is not, however, typically necessary to move any of the furniture as a masking technique can be used to conveniently accommodate these objects. The customer positions or places a plurality of reference marks on the floor of the environment of use. These reference marks are preferably in the form of sheets of ordinary paper, 8.5 inch by 11 inch or larger, positioned so as to indicate or form a square or rectangle or at least the approximate corners of the square or rectangle.

Next, using the digital camera or scanner, the customer generates a first digital image of the environment of use with the reference marks present, and then a second digital image with the reference marks removed. The angles or perspectives at which these two images are taken should be substantially the same. The customer may also be asked to manually or electronically complete a questionnaire regarding such information as, for example, the spacing or distance between the papers or other reference marks; the projected use of the floor covering (e.g., heavy traffic or light traffic); any preferred or non-preferred colors or patterns, sizes, and shape (e.g., rectangular, elongated rectangular, round, or oval); and any preferred pattern orientation. Next, the customer, using the first PC, transmits via the network the first and second digital images and, as appropriate, the questionnaire to the second PC.

A Profiler, using the second PC, on which is stored the computer program of the present invention, receives these submissions. The computer program generates a Control Panel interface screen to facilitate interaction between the Profiler and the computer program. The Control Panel presents a number of data fields and selectable buttons and a Viewer portion wherein can be displayed the customer-supplied digital images. With the first digital image displayed in the Viewer portion of the Control Panel, the Profiler identifies the reference marks for the computer program by selecting those marks using a conventional electronic input selection mechanism. The Profiler then enters the widthwise and heightwise spacing of the identified reference marks. The computer program then creates an outline of the floor covering and an Anchor Point or Rug Placement Attachment Point which determines placement of the floor covering in the finished preview presentation image. Thereafter, each floor covering, regardless of size or shape is placed and replaced in the preview presentation image with regard to the Anchor Point. By default, the Anchor Point is centered in relation to the reference marks, though, as desired, it may be offset by a specified distance.

Next, the Profiler sets or defines a range of widths and heights of floor coverings that will fit into the environment of use. Then the computer program automatically performs color sampling based upon the reference marks, and then manipulates the digital image of the floor covering so that, when combined with the second digital image, the floor covering will be properly angled, shaded, and otherwise conditioned to reflect the corresponding conditions of the environment of use, thereby advantageously providing a more accurate preview presentation image.

Next, the Profiler creates a mask file for at least some of the any furniture, walls, or other items appearing in the second digital image that would overlap the floor covering. The finished preview presentation image is a composite of layers, including a first layer which is the base or floor upon which the floor covering will rest; a second layer which is the floor covering itself; and a third layer which is the furniture or fixtures. Preferably, only those portions of the furniture that would overlap the floor covering are masked, rather than the entire furniture item, thereby saving valuable memory, processing, and other computer resources as well as Profiler time and labor. The computer program creates a preliminary graphic mask that masks out portions of the second digital image that will not overlap even the largest allowable floor covering. This preliminary graphic mask is created automatically and significantly reduces the time required for the Profiler to mask the furniture because the Profiler need concentrate only on the furniture remaining in the preliminary graphic mask.

Then the computer program combines the manipulated digital image of the floor covering with the second digital image of the environment of use to create the preview presentation image. This process is repeated for each of a variety of different floor coverings, each of which must comport with the specified ranges of width and height, to result in a corresponding number of different preview presentation images. If the aforementioned questionnaire is used, the number of preview presentation images may be advantageously limited to include only those floor coverings that meet the customer's specific criteria, thereby further saving valuable memory, network bandwidth, processing, and other computer resources. Thereafter, the preview presentation images may be accessed via the network by the customer using the first PC, and displayed within a template that allows the customer to navigate among the various preview presentation images; identifies the particular floor covering being displayed in each image; and facilitates purchasing the floor covering being displayed.

Thus, it will be appreciated that the method and computer program of the present invention provides a number of distinct advantages over the prior art, including, for example, allowing for a more realistic yet practical and economical preview presentation that accurately depicts the floor covering as it would appear in the intended environment of use. Manipulating the coloration, size, shading, perspective and other conditions of the floor covering to reflect the corresponding conditions of the intended environment of use further adds to the accuracy of the preview presentation image.

Additionally, masking only those portions of any furniture, fixtures or other objects, rather than the entire objects, that would rest upon or otherwise overlap the floor covering advantageously saves valuable memory space and other computing resources.

These and other important aspects of the present invention are more fully described in the section entitled DETAILED DESCRIPTION OF A PREFERRED EMBODIMENT, below.

### BRIEF DESCRIPTION OF THE DRAWING FIGURES

A preferred embodiment of the present invention is described in detail below with reference to the attached drawing figures, wherein:

FIG. 1 is a depiction of a preferred first system for implementing the method of the present invention;

FIG. 2 is a depiction of a preferred second system for implementing the method of the present invention;

FIG. 3 is a first part of a flowchart setting forth preferred steps in performing the method of the present invention;

FIG. 4 is a second part of the flowchart of FIG. 3;

FIG. 5 is a first digital image generated in accordance with the method as set forth in FIG. 3;

FIG. 6 is a second digital image generated in accordance with the method as set forth in FIG. 3;

FIG. 7 is a screen capture of a control panel generated by a computer program of the present invention and used in implementing the method as set forth in FIGS. 3 and 4; and

FIG. 8 is a screen capture of a preliminary graphic mask;

FIG. 9 is a screen capture of parts of furniture that have been masked using a masking technique; and

FIG. 10 is a screen capture of a preview presentation generated by the computer program.

### DETAILED DESCRIPTION OF THE PREFERRED EMBODIMENT

With reference to the figures, a method and a computer program is described herein in accordance with a preferred embodiment of the present invention. Broadly, the method and computer program allow for and facilitate previewing an area rug or other floor covering in a room, hallway, or other intended environment wherein the floor covering will be placed, located, or otherwise used. In more detail, a digital image of the floor covering is shaded, scaled, angled, or otherwise manipulated to reflect the corresponding conditions of the environment of use; combined with a digital image of the intended environment of use so as to present a substantially accurate and realistic preview presentation image; and made available, such as, for example, via a network, for viewing. The present invention is particularly well-suited for previewing floor coverings that are smaller in size (i.e., not wall-to-wall) than the room in which they are to be placed

Referring particularly to FIG. 1, a preferred first embodiment of a system 10 is shown operable to implement the method and the computer program of the present invention. The system 10 broadly comprises a first PC 12 and a second PC 14; a network 16; and a digital camera 18 or scanner 20. The first and second PCs 12,14 may be any substantially conventional and commonly available computing devices, such as, for example, desktops, laptops, notebooks, or hand-helds, having sufficient resources and capabilities to perform the functions described herein, including storing and executing software and accessing and communicating via the network 16.

The network 16 may be any substantially conventional communication or data transfer network, such as, for example, a local area network (LAN) or wide area network (WAN) such as the Internet. When performing the steps of the method, described in more detail below, the first and second PCs 12,14 communicate with each other and exchange data via the network 16.

The digital camera 18 may be any substantially conventional digital image capturing device operable to capture a digital image of the environment of use and to upload the digital image to the first PC 12. The scanner 20 may be any substantially conventional electronic scanning device operable to convert a non-electronic or “hardcopy” image of the environment of the use into a digital image and to upload the digital image to the first PC 12. It will be appreciated that the digital camera 18 and the scanner 20 both perform the function of providing the digital image for upload to the first PC 12, and that, therefore, the system 10 requires only one of these two components, though access to both may be desirable under certain circumstances.

Referring also to FIG. 2, a preferred second embodiment of the system 110 is shown operable to implement the method and the computer program of the present invention. The system 100 broadly comprises a kiosk PC 115; a digital camera port 119; and the scanner 120. The kiosk PC 115 combines the functions of the first and second PCs 12,14 of the preferred first system 10 described above, and may be otherwise physically and operationally similar or identical to those computing devices. Because the kiosk PC 115 combines the functions of the first and second PCs 12,14, there is no need for the network 16, though access to the network 16 may still be desirable, such as, for example, for transmitting or otherwise making the preview presentation images available to a home or other remote PC. The digital camera port 119 allows a customer to connect the digital camera 18 in order to upload the digital image of the environment of use to the kiosk PC 115. The scanner 120 functions as described above.

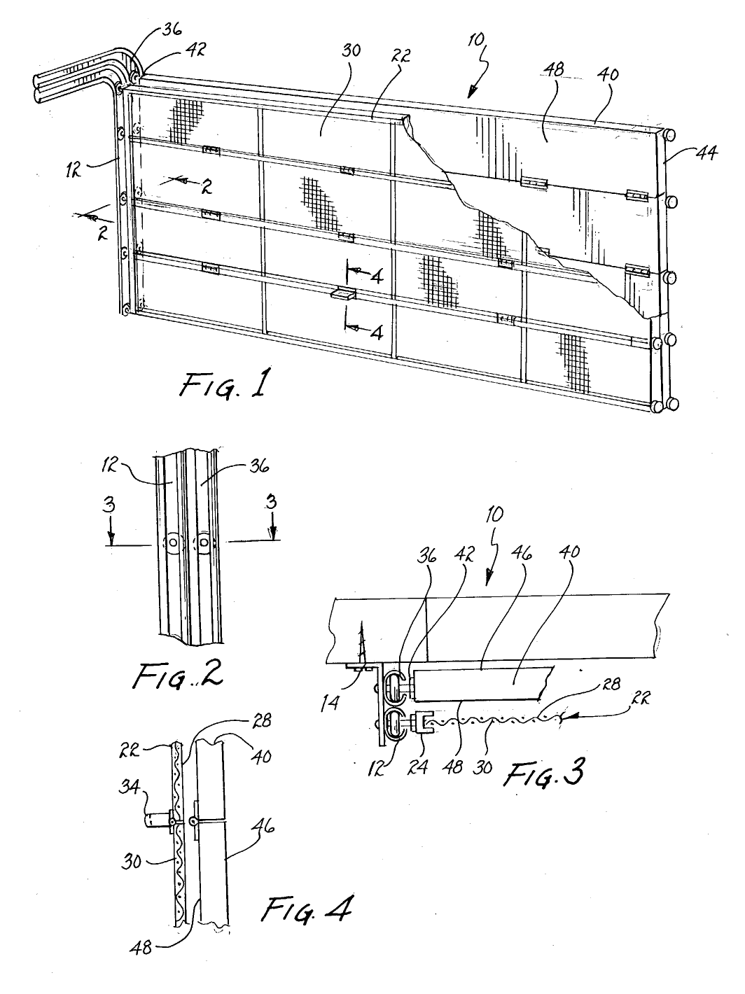

Referring also to FIGS. 3-10, the method proceeds as follows. The customer may first move all or some of any furniture from the specific area in the environment of use in which the floor covering will be located, as depicted in box 210. It is not, however, typically necessary to move any of the furniture as a masking technique can be used to conveniently accommodate these objects.

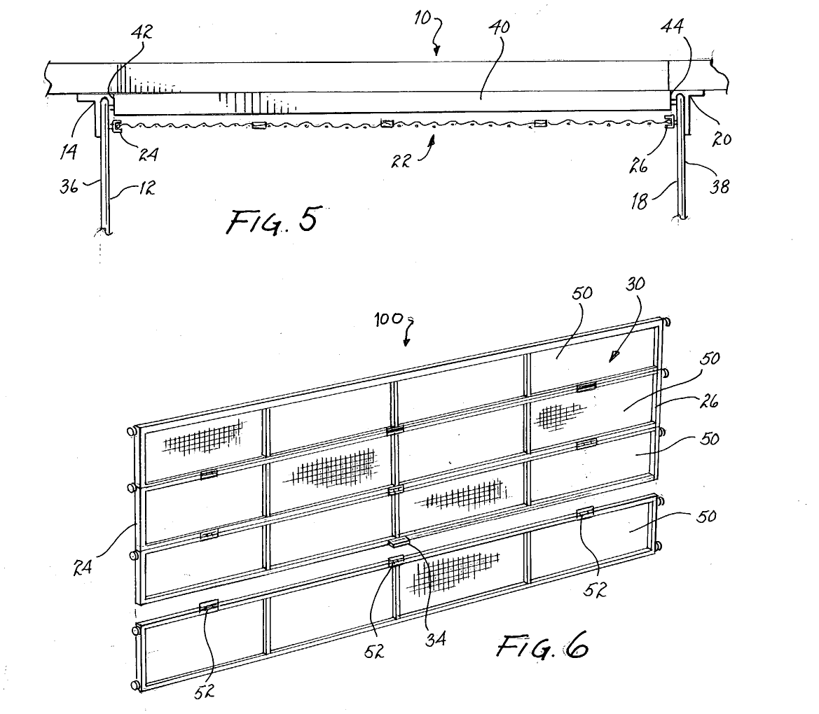

Then the customer positions or places a plurality of reference marks 312 (see FIG. 5) on the floor of the environment of use, as depicted in box 212. These reference marks 312 are preferably in the form of sheets of ordinary paper, 8.5 inch by 11 inch or larger, positioned so as to indicate or form, within approximately one or two inches, a square or rectangle or at least the approximate corners of a square or rectangle. It is not necessary that the reference marks 312 define the size or placement of the floor covering, though they may, as desired, provide an indication thereof. It is preferable, however, that the customer provide an indication of the desired orientation of any pattern or image that might appear in the rug. Furthermore, the paper should be of a known, suitable shade, such as, for example, white, to facilitate color calibration by the computer program. In situations where the color of the floor is so similar to the color of the paper that it is likely to be difficult or impossible to distinguish the paper in the first digital image, a small dark object, such as, for example, a dollar bill or compact disk case, should be placed at the exterior corner of the paper to facilitate identification thereof by the Profiler.

The reference marks 312 must be such as to facilitate deriving both an indication of lighting effects and an indication of scale. The indication of lighting effects can be derived from the shading of the paper; the indication of scale can be derived from the size and spacing of the paper or may be expressly provided by the customer. Preferably, size can be easily derived by counting the number of sheets of paper forming the square or rectangle. Alternatively, if other marks are used, or if only the corners of the square or rectangle are indicated, then the customer has preferably spaced the marks using integer increments of a standard measuring unit (e.g., inches, feet, centimeters, meters), and expressly provides the distances between marks or corners.

Next, using the digital camera 18 or scanner 20, the customer generates a first digital image (see FIG. 5) 310 of the environment of use with the reference marks 312 present, as depicted in box 214. The angle from which the first digital image is created is unimportant, but should approximately correspond to a standing or sitting person's actual perspective so that the coloration and shading of the finished preview presentation will be as realistic as possible. Then the customer generates a second digital image 314 (see FIG. 6) of the environment of use with the reference marks 312 removed, as depicted in box 216. The angle from which the second digital image 314 is created should be substantially the same angle from which the first digital image 310 was created. Use of a tripod or other support will facilitate achieving substantially the same angle.

The customer may be asked to manually or electronically complete a questionnaire, as depicted in box 218, regarding such information as, for example, the spacing or distance between the papers or other reference marks 312; the projected use of the floor covering (e.g., heavy traffic or light traffic); any preferred or non-preferred colors or patterns, sizes, and shape (e.g., rectangular, elongated rectangular, round, or oval); and any preferred pattern orientation.

Next, the customer, using the first PC 12, transmits via the network 16 the first and second digital images 310,314 and, as appropriate, the questionnaire to the second PC 14, as depicted in box 220. A Profiler, using the second PC 14, receives these submissions.

The second PC 14 stores and executes the computer program of the present invention. The computer program may be implemented using any conventional computer programming language, such as, for example, Visual Basic. Though creating the computer program is, in light of the description set forth herein, within the ability of one with ordinary skill in the art, a computer listing appendix of exemplary source code operable to implement the present invention is submitted herewith and incorporated herein by reference. It will be appreciated that other substantially equivalent mechanisms may be devised for implementing the present invention, particularly with regard to minor changes in presentation or appearance, and that such equivalents are considered to be within the scope of the present invention.

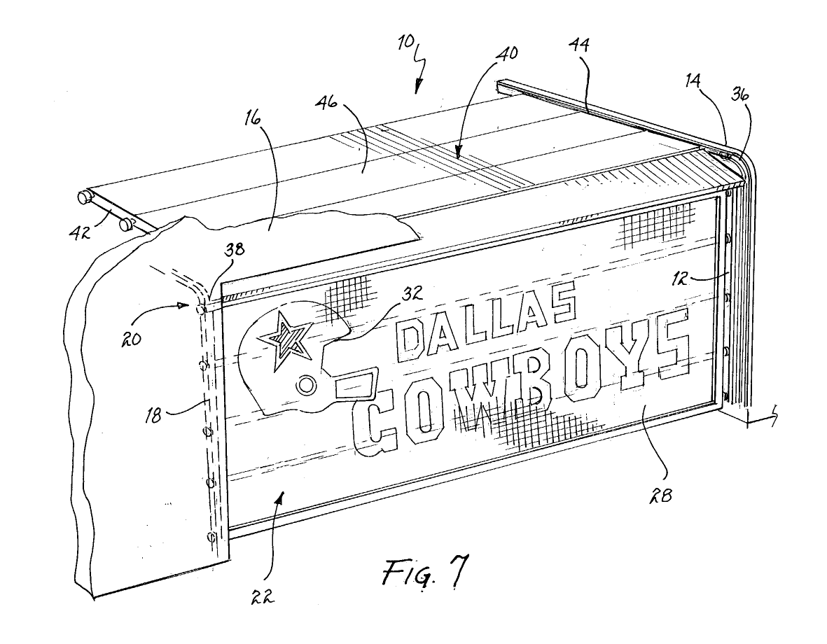

The computer program generates a Control Panel interface screen 316 (see FIG. 7) to facilitate interaction between the Profiler and the computer program. The Control Panel 316 presents a number of data fields and selectable buttons, including Customer Numberfield 320; a Profile Numberfield 322; a Pattern Marks (Width) field 324 and a Pattern Marks (Height) field 326; a; a Customer Size Range (Width) field 328 and a Customer Size Range (Height) field 330; a Location “X” field 332 and a Location “Y” field 334; a Rug Placement Attachment Point field 336; and an Offset “X” field 338 and an Offset “Y” field 340; a plurality of Perspective Plane Coordinates fields 342; and Red, Green, and Blue fields 344; and a Build Pages and Scripts Button 346. The Control Panel 316 also presents a Viewer portion 348 wherein can be displayed the customer-supplied digital images 310,314.

The Profiler, using the computer program, performs a number of functions, including manipulating the perspective, orientation, shading or brightness, and scale of the digital image of the floor covering to condition it to reflect the corresponding conditions of the environment of use; masking furniture or other fixtures in the customer-supplied digital images 310,314; and generating the finished preview presentation images.

A customer number and profile number for associating each final preview presentation image with a specific customer is entered by the Profiler or by the computer program into, respectively, the Customer Number field 320 and the Profile Number field 322. Then, with the first digital image 310 displayed in the Viewer portion 348 of the Control Panel 316, the Profiler identifies the reference marks 312 to the computer program by selecting those marks 312 on the image 310 using a conventional electronic input mechanism (e.g., a computer mouse, stylus, or touchscreen), as depicted in box 222. This may be accomplished, for example, by selecting the outer corner of each of the pieces of paper appearing in the first digital image 310. The Profiler will then enter the widthwise and heightwise spacing of the identified reference marks into, respectively, the Pattern Marks (Width) field 324 and the Pattern Marks (Height) field 326, as depicted in box 224. The coordinates of the reference marks and the known distances between them enable the computer program to establish the perspective orientation and scale of the floor with respect to the digital camera 18 used to generate the first digital image 310. Thereafter, the computer program can transform any photographically-textured two dimensional polygon, circle, or oval of known size so as to have a corresponding proper skewed perspective orientation and scale at any location within the second digital image. This technique is particularly adaptive to typical two dimensional area rug shapes such as squares, rectangles, circles, and ovals.

Next, the Profiler sets or defines a range of widths and heights of floor coverings that will fit into the environment of use, as depicted in box 226. To do this, the Profiler enters a preferred minimum and maximum width and minimum and maximum height of the floor covering into, respectively, the Customer Size Range (Width) field 328 and the Customer Size Range (Height) field 330. It will be appreciated that these values are not limited to the widthwise and heightwise spacing of the reference points, and may be based on values provided by the customer.

The computer program then creates an outline (as seen in FIG. 7) of the floor covering and an Anchor Point or Rug Placement Attachment Point which determines placement of the floor covering in the preview presentation image, as depicted in box 228. The computer program will enter corresponding values into the Location “X” field 332, Location “Y” field 334, and the Rug Placement Attachment Point field 336. Thereafter, each floor covering, regardless of size or shape is placed and replaced in the preview presentation image with regard to the Anchor Point. By default, the Anchor Point will be centered in relation to the reference marks, but it may be moved or offset, as desired, by the Profiler. Thus, the Offset “X” field 338 and the Offset “Y” field 340 will both default to 0; to offset the Anchor Point, an offset value, in inches, is entered into either or both of these fields 338,340.

Then the computer program performs color sampling on the first digital image 310 of the environment is use based upon the reference marks 312, as depicted in box 230. The computer program then manipulates the digital image of the floor covering, as depicted in box 232, so that the image, when combined with the second digital image 310 of the environment of use, will affect the proper angle and shading and be otherwise conditioned to reflect corresponding conditions of the environment of use, thereby providing a more accurate preview presentation. The corresponding computer-generated perspective and color sampling values will appear in the plurality of Perspective Plane Coordinates fields 342 and the Red, Green, and Blue fields 344.

Next, the Profiler creates a mask file for at least some of the any furniture, walls, or other items appearing in the second digital image 314 that would overlap the floor covering, as depicted in box 234. The finished preview presentation image is a composite of layers, including a first layer which is the base or floor upon which the floor covering will rest; a second layer which is the floor covering itself; and a third layer which is the furniture or fixtures. Preferably, as seen in FIG. 9, only those portions 352 of the furniture that would overlap the floor covering are masked, rather than the entire furniture item, thereby saving valuable memory, processing, and other computer resources as well as Profiler time and labor. In order to accomplish this, the computer program creates a preliminary graphic mask 353 (see FIG. 8) that masks out portions of the second digital image 314 that will not overlap even the largest allowable floor covering plus three inches (i.e., would not fall within the outline seen in FIG. 7). This preliminary graphic mask 353 is created automatically and significantly reduces the time required for the Profiler to mask the furniture because the Profiler need concentrate only on the furniture or portions of furniture remaining in the preliminary graphic mask 353. The Profiler masks the furniture or portions of furniture 352, if any, that will fall upon or overlap the floor covering. The corresponding areas of the floor covering are assigned a transparent color (this is possible using, for example, a GIF format). Alternatively, those portions of the floor covering could be removed altogether from the digital image of the floor covering.

Then the Profiler selects the Build Pages and Scripts button 346 to cause the computer program to create, for each style and size of floor covering that fits within the minimum and maximum width and minimum and maximum height, the preview presentation image 354 (see FIG. 10) of the floor covering, properly positioned and accurately scaled, shaded, and otherwise conditioned, within the environment of use, as depicted in box 236. If the aforementioned questionnaire is used, the number of preview presentation images 354 may be advantageously limited to include only those floor coverings that meet the customer's specific criteria (e.g., color, pattern, shape), thereby further saving valuable memory, processing, and other computer resources. Alternatively, the customer may be provided with a catalog of electronically selectable floor coverings, possibly in thumbnail form. In this latter implementation, the customer can select the particular floor coverings for which they would like to see a preview presentation image 354, thereby further saving valuable memory, processing, and other computer resources.

Thereafter the preview presentation images 354 may be accessed via the network 16 by the customer using the first PC 12 and displayed, as depicted in box 238, within a template 356 (see FIG. 10) that allows the customer to navigate among the various preview presentation images 354; identifies the particular floor covering being displayed in each image; and facilitates purchasing the floor covering being displayed in each image 354 using, for example, a “shopping cart” or other suitable technique. The preview presentation images 354 may be stored on the second PC 14, or on another computing or memory device accessible via the network 16, for a limited period of time (e.g., thirty days or one month) during which time the customer can, as desired, repeatedly access, print, and download them.

It will be appreciated that the number of digital images required by the Profiler may vary. In one embodiment, for example, only the first digital image may be required, in which case the reference marks may be removed or covered in some manner. For example, the floor covering may be used to cover the reference marks, or, if the reference marks are outside the area of the floor covering, a portion of the existing floor may be copied and pasted or otherwise reproduced over the reference marks. Similarly, three digital images may be used, including a first image showing the reference marks but no furniture, a second digital image without reference marks or furniture, and a third digital image showing the furniture but no reference marks. In each case, the method set forth above involving two digital images is substantially similar or the same but for appropriate modification.

From the preceding description, it will be appreciated that the method and computer program of the present invention provides a number of distinct advantages over the prior art, including, for example, allowing for a more realistic yet practical and economical preview presentation that accurately depicts the floor covering as it would appear in the environment of use. Manipulating the coloration, size, shading, perspective, and other conditions of the floor covering to reflect the corresponding conditions of the environment of use further adds to the accuracy of the preview presentation.

Additionally, masking only those portions of any furniture, fixtures or other objects, rather than the entire objects, that rest upon or otherwise overlap the floor covering advantageously saves valuable memory space and other computing resources as well as Profiler time and labor.

Although the invention has been described with reference to the preferred embodiment illustrated in the attached drawings, it is noted that equivalents may be employed and substitutions made herein without departing from the scope of the invention as recited in the claims. For example, though a preferred embodiment of the method and computer program has been described in detail, many of these details, particularly with regard to presentation and appearance, may be changed without departing from the contemplated scope of the present invention. Also, it will be appreciated that some or all of the functions attributed to the Profiler may be performed instead by the customer, another user, or the computer program, or by any combination thereof, particularly in the preferred second embodiment involving the kiosk-based system.

Having thus described the preferred embodiment of the invention, what is claimed as new and desired to be protected by Letters Patent includes the following:

1. A method of previewing a floor covering in an intended environment of use, the method comprising the steps of:
(a) receiving a first digital image of the intended environment of use, wherein the first digital image includes a plurality of reference marks;
(b) manipulating a digital image of the floor covering to reflect one or more corresponding conditions of the intended environment of use as determined from the first digital image of the intended environment of use; and
(c) combining the first digital image of the intended environment of use with the manipulated digital image of the floor covering and eliminating the plurality of reference marks from the first digital image to generate a preview presentation image.

2. The method as set forth in claim 1, wherein the floor covering is an area rug.

3. The method as set forth in claim 1, wherein the one or more conditions of the intended environment of use include
shading, such that the digital image of the floor covering is manipulated to reflect a shading condition of the intended environment of use;
angular perspective, such that the digital image of the floor covering is manipulated to reflect an angular perspective condition of the intended environment of use; and
scale, such that the digital image of the floor covering is manipulated to reflect a scale condition of the intended environment of use.

4. The method as set forth in claim 1, further including the step of establishing an anchor point to facilitate combining the first digital image of the intended environment of use with the digital image of the floor covering to generate the preview presentation image.

5. The method as set forth in claim 1, further including the step of establishing a minimum and a maximum width and a minimum and a maximum height for the floor covering.

6. The method as set forth in claim 1, further including the step of masking at least some of any objects that appear in the first digital image to be in an area of the intended environment of use where the floor covering would be located, so that the any objects appear in the preview presentation image to be in front of the digital image of the floor covering.

7. The method as set forth in claim 6, wherein, if a first portion of the any object appears to be in the area where the floor covering would be located, and a second portion of the any object does not appear to be in the area where the floor covering would be located, then only the first portion is masked.

8. The method as set forth in claim 7, wherein a part of the digital image of the floor covering corresponding to the masked first portion of the any object is made transparent.

9. The method as set forth in claim 7, wherein a part of the digital image of the floor covering corresponding to the masked first portion of the any object is removed from the digital image of the floor covering.

10. The method as set forth in claim 1, further including the step of repeating step (b) and (c) for a plurality of digital images of a plurality of different floor coverings to generate a corresponding number of different preview presentation images.

11. The method as set forth in claim 1, further including the step of receiving a completed questionnaire and using the completed questionnaire to facilitate manipulating the digital image of the floor covering to reflect the corresponding condition of the intended environment of use.

12. A method of previewing a floor covering in an intended environment of use, the method comprising the steps of:
(a) receiving a first digital image of the intended environment of use, wherein the first digital image includes a plurality of reference marks;
(b) receiving a second digital image of the intended environment of use, wherein the second digital image does not include the plurality of reference marks;
(c) manipulating a digital image of the floor covering to reflect one or more corresponding conditions of the intended environment of use as determined from the first digital image of the intended environment of use; and
(d) combining the second digital image of the intended environment of use with the manipulated digital image of the floor covering to generate a preview presentation image.

13. The method as set forth in claim 12, wherein the floor covering is an area rug.

14. The method as set forth in claim 12, wherein the first digital image and the second digital image are both taken from approximately the same perspective.

15. The method as set forth in claim 12, wherein the one or more conditions of the intended environment of use include
shading, such that the digital image of the floor covering is manipulated to reflect a shading condition of the intended environment of use;
angular perspective, such that the digital image of the floor covering is manipulated to reflect an angular perspective condition of the intended environment of use; and
scale, such that the digital image of the floor covering is manipulated to reflect a scale condition of the intended environment of use.

16. The method as set forth in claim 12, further including the step of establishing an anchor point to facilitate combining the second digital image of the intended environment of use with the digital image of the floor covering to generate the preview presentation image.

17. The method as set forth in claim 12, further including the step of establishing a minimum and a maximum width and a minimum and a maximum height for the floor covering.

18. The method as set forth in claim 12, further including the step of masking at least some of any objects that appear in the second digital image to be in an area of the intended environment of use where the floor covering would be located, so that the any objects appear in the preview presentation image to be in front of the digital image of the floor covering.

19. The method as set forth in claim 18, wherein, if a first portion of the any object appears to be in the area where the floor covering would be located, and a second portion of the any object does not appear to be in the area where the floor covering would be located, then only the first portion is masked.

20. The method as set forth in claim 19, wherein a part of the digital image of the floor covering corresponding to the masked first portion of the any object is made transparent.

21. The method as set forth in claim 19, wherein a part of the digital image of the floor covering corresponding to the masked first portion of the any object is removed from the digital image of the floor covering.

22. The method as set forth in claim 12, further including the step of repeating steps (c) and (d) for a plurality of digital images of a plurality of different floor coverings to generate a corresponding number of different preview presentation images.

23. The method as set forth in claim 12, further including the step of receiving a completed questionnaire and using the completed questionnaire to facilitate manipulating the digital image of the floor covering to reflect the corresponding condition of the intended environment of use.

24. A method of previewing an area rug in an intended environment of use, the method comprising the steps of:
(a) receiving a first digital image of the intended environment of use, wherein the first digital image includes three or more reference marks;
(b) receiving a second digital image of the intended environment of use, wherein the second digital image does not include the three or more reference marks, and wherein the first digital image and the second digital image are both taken from approximately the same perspective;
(c) establishing a minimum and a maximum width and a minimum and a maximum height for the area rug;
(d) establishing an anchor point in the second digital image to facilitate combining the second digital image with the digital image of the area rug;
(e) manipulating a digital image of the area rug to reflect one or more corresponding conditions of the intended environment of use as determined from the first digital image of the intended environment of use;
(f) combining the second digital image of the intended environment of use with the digital image of the area rug to generate a preview presentation image; and
(g) repeating steps (e) and (f) for a plurality of digital images of a plurality of different floor coverings, all of which fall within the minimum and maximum width and the minimum and maximum height, to generate a corresponding number of different preview presentation images.

25. The method as set forth in claim 24, wherein the one or more conditions of the intended environment of use include
shading, such that the digital image of the floor covering is manipulated to reflect a shading condition of the intended environment of use;
angular perspective, such that the digital image of the floor covering is manipulated to reflect an angular perspective condition of the intended environment of use; and
scale, such that the digital image of the floor covering is manipulated to reflect a scale condition of the intended environment of use.

26. The method as set forth in claim 24, further including the step of masking at least some of any objects that appear in the second digital image in an area of the intended environment of use where the area rug would be located, so that the any objects appear in the preview presentation image to be in front of the digital image of the area rug.

27. The method as set forth in claim 26, wherein, if a first portion of the any object appears in the area where the area rug would be located, and a second portion of the any object does not appear in the area where the area rug would be located, then only the first portion is masked.

28. The method as set forth in claim 27, wherein a part of the digital image of the area rug corresponding to the masked first portion of the any object is made transparent.

29. The method as set forth in claim 27, wherein a part of the digital image of the area rug corresponding to the masked first portion of the any object is removed from the digital image of the area rug.

30. The method as set forth in claim 24, further including the step of receiving a completed questionnaire and using the completed questionnaire to facilitate manipulating the digital image of the area rug to reflect the corresponding condition of the intended environment of use.

31. A method of previewing an area rug in an intended environment of use, the method comprising the steps of:
(a) receiving a first digital image of the intended environment of use, wherein the first digital image includes three or more reference marks;
(b) receiving a second digital image of the intended environment of use, wherein the second digital image does not include the three or more reference marks, and wherein the first digital image and the second digital image are both taken from approximately the same perspective;
(c) establishing a minimum and a maximum width and a minimum and a maximum height for the area rug;
(d) establishing an anchor point in the second digital image to facilitate combining the second digital image with the digital image of the area rug;
(e) manipulating a digital image of the area rug to reflect one or more corresponding conditions of the intended environment of use as determined from the first digital image of the intended environment of use;
(f) masking at least some of any objects that appear in the second digital image to be in an area of the intended environment of use where the area rug would be located, wherein if a first portion of the any object appears in the area where the area rug would be located, and a second portion of the any object does not appear in the area where the area rug would be located, then only the first portion is masked;
(g) combining the second digital image of the intended environment of use with the digital image of the area rug to generate a preview presentation image; and
(h) repeating steps (e), (f), and (g) for a plurality of digital images of a plurality of different area rugs, all of which fall within the minimum and maximum width and the minimum and maximum height, to generate a corresponding number of different preview presentation images.

32. The method as set forth in claim 31, wherein the one or more conditions of the intended environment of use include
shading, such that the digital image of the floor covering is manipulated to reflect a shading condition of the intended environment of use;
angular perspective, such that the digital image of the floor covering is manipulated to reflect an angular perspective condition of the intended environment of use; and
scale, such that the digital image of the floor covering is manipulated to reflect a scale condition of the intended environment of use.

33. The method as set forth in claim 31, wherein a part of the digital image of the area rug corresponding to the masked first portion of the any object is made transparent.

34. The method as set forth in claim 31, wherein a part of the digital image of the area rug corresponding to the masked first portion of the any object is removed from the digital image of the area rug.

35. The method as set forth in claim 31, further including the step of receiving a completed questionnaire and using the completed questionnaire to facilitate manipulating the digital image of the area rug to reflect the corresponding condition of the intended environment of use.

36. A computer program for facilitating previewing an area rug in an intended environment of use, the computer program comprising:
a code segment for facilitating receiving a first digital image of the intended environment of use, wherein the first digital image includes three or more reference marks;
a code segment for facilitating receiving a second digital image of the intended environment of use, wherein the second digital image does not include the three or more reference marks, and wherein the first digital image and the second digital image are both taken from approximately the same perspective;
a code segment allowing for establishing a minimum and a maximum width and a minimum and a maximum height for the area rug;
a code segment for establishing an anchor point in the second digital image to facilitate combining the second digital image with the digital image of the area rug;
a code segment for facilitating manipulating a digital image of the area rug to reflect one or more corresponding conditions of the intended environment of use as determined from the first digital image of the intended environment of use;
a code segment for facilitating masking at least some of any objects that appear in the second digital image to be in an area of the intended environment of use where the area rug would be located, wherein if a first portion of the any object appears in the area where the area rug would be located, and a second portion of the any object does not appear in the area where the area rug would be located, then only the first portion is masked; and
a code segment for combining the second digital image of the intended environment of use with the digital image of the area rug to generate a preview presentation image.
